(19) United States
(12) Patent Application Publication
(10) Pub. No.: US 2025/0109458 A1
(43) Pub. Date: Apr. 3, 2025

(54) SYSTEMS AND METHODS FOR SELECTIVE LEACHING OF MANGANESE FROM ORES

(71) Applicant: MICHIGAN TECHNOLOGICAL UNIVERSITY, Houghton, MI (US)

(72) Inventor: Timothy C. Eisele, Houghton, MI (US)

(21) Appl. No.: 18/390,861

(22) Filed: Dec. 20, 2023

Related U.S. Application Data
(60) Provisional application No. 63/586,911, filed on Sep. 29, 2023.

(51) Int. Cl. C22B 47/00; C22B 3/18

(52) U.S. Cl. CPC C22B 47/00; C22B 3/18

(57) ABSTRACT

Described herein are systems and methods for selectively extracting manganese from ore. In some embodiments, the systems and methods comprise the use of an acidic solution comprising reduced iron for manganese extraction. In some embodiments, the systems and methods comprise the use of one or more metal-reducing microorganisms for manganese extraction.

### CROSS-REFERENCE TO RELATED APPLICATIONS

This application claims priority to U.S. Provisional Patent Application No. 63/586,911, filed on Sep. 29, 2023, which is incorporated by reference herein in its entirety.

### FEDERALLY SPONSORED RESEARCH

This invention was made with government support under grant number DE-AR0001336 awarded by the Advanced Research Projects Agency-Energy (ARPA-E). The government has certain rights in this invention.

### TECHNICAL FIELD

This disclosure generally relates to systems and methods for selectively leaching and extracting manganese from ores.

### BACKGROUND

Manganese ore deposits are abundant but are selectively scattered around the world. The United States alone imported about 441,000 metric tons of manganese ores in 2015 to meet its industrial demands since manganese is not domestically produced despite the presence of ore reserves. Large deposits of manganese are present in various areas, but these deposits are generally low grade and the production of manganese using conventional methods is uneconomical and detrimental to the environment. Manganese ores are currently treated using conventional methods such as washing, gravity separation, magnetic separation, froth flotation, and chemical processing. These methods consume a large amount of energy and are not always economically suitable for low grade manganese ores.

Previous research in the field has also investigated the use of microorganisms that can produce organic acids in an aerobic environment to dissolve manganese from ores through a leaching process. However, these bioleaching processes rely on organic acid production by aerobic bacteria, which requires a constant supply of oxygen. Further, these bioleaching processes are not selective for manganese and have yet to demonstrate sufficient efficiency for commercialization. For example, previous bioleaching studies performed at low pH (e.g., pH˜2.0) have demonstrated that iron also dissolves readily in solution, which is problematic if the goal is to separate manganese from iron. In addition, these bioleaching processes can also generate large amounts of undesirable precipitated manganese carbonate due to carbon dioxide produced during leaching that reacts with manganese. No studies have been able to demonstrate a leaching process where various dissolved metals can be separated for the selective extraction of manganese from ores.

Thus, what is needed are novel sustainable and efficient systems and methods for selectively leaching and extracting manganese from ores, including low grade manganese ores. Such systems and methods would be useful in a variety of research, environmental, and commercial applications.

### SUMMARY

One embodiment described herein is a method of selectively extracting manganese from an ore, the method comprising: incubating an ore comprising manganese-bearing oxide minerals with a solution comprising reduced iron for a period of time sufficient to generate soluble reduced manganese; wherein the reduced iron is precipitated as insoluble iron; and wherein a pH of the solution is maintained below about 5.5. In one aspect, the method does not generate manganese carbonate. In another aspect, the manganese-bearing oxide minerals are Mn₂O₃, MnO₂, hydrated manganese oxides, or combinations thereof. In another aspect, the soluble reduced manganese is dissolved Mn²⁺. In another aspect, the reduced iron is dissolved ferrous iron (Fe²⁺). In another aspect, the insoluble iron is Fe₂O₃, FeOOH, Fe(OH)₃, or combinations thereof. In another aspect, the pH of the solution is maintained from about 4.0 to about 5.5. In another aspect, the period of time sufficient to generate the soluble reduced manganese and the insoluble iron ranges from about 1 day to about 6 months. In another aspect, the method is performed at a temperature ranging from about 0° C. to about 35° C. In another aspect, the method is performed at a pressure ranging from about 1 atm to about 100 atm. In another aspect, the solution comprising reduced iron is first generated by incubating an ore comprising iron oxides with one or more dissimilatory metal-reducing microorganisms and a food source to generate reduced iron and carbon dioxide in the solution, and allowing the carbon dioxide to release from the solution. In another aspect, the ore comprising iron oxides comprises only iron oxides. In another aspect, the ore comprising iron oxides and the ore comprising manganese-bearing oxide minerals are the same ore. In another aspect, the ore comprising iron oxides and the ore comprising manganese-bearing oxide minerals are different ores. In another aspect, the food source comprises sugars, organic acids, water, or combinations thereof. In another aspect, the food source is derived from natural biomass. In another aspect, the natural biomass comprises decomposing cattail (Typha latifolia). In another aspect, the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof. In another aspect, the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof. In another aspect, the method is performed in situ at the natural site of the ore comprising manganese-bearing oxide minerals. In another aspect, the method is not performed in situ at the natural site of the ore comprising manganese-bearing oxide minerals. In another aspect, the method is performed in situ at the natural site of the ore comprising iron oxides. In another aspect, the method is not performed in situ at the natural site of the ore comprising iron oxides.

Another embodiment described herein is a system for selectively extracting manganese from an ore, the system comprising: an ore comprising manganese-bearing oxide minerals; and a solution comprising reduced iron, wherein a pH of the solution is maintained below about 5.5. In one aspect, the system does not generate manganese carbonate. In another aspect, the manganese-bearing oxide minerals are Mn₂O₃, MnO₂, hydrated manganese oxides, or combinations thereof. In another aspect, the system generates soluble reduced manganese. In another aspect, the reduced iron is precipitated as insoluble iron when the soluble reduced manganese is generated. In another aspect, the soluble reduced manganese is dissolved Mn²⁺. In another aspect, the reduced iron is dissolved ferrous iron (Fe²⁺). In another aspect, the insoluble iron is Fe₂O₃, FeOOH, Fe(OH)₃, or combinations thereof. In another aspect, the pH of the solution is maintained from about 4.0 to about 5.5. In another aspect, the system operates at a temperature ranging from about 0° C. to about 35° C. In another aspect, the system operates at a pressure ranging from about 1 atm to about 100 atm. In another aspect, the solution comprising reduced iron is generated by incubating an ore comprising iron oxides with one or more dissimilatory metal-reducing microorganisms and a food source to generate reduced iron and carbon dioxide in the solution, wherein the carbon dioxide is released from the solution. In another aspect, the ore comprising iron oxides comprises only iron oxides. In another aspect, the ore comprising iron oxides and the ore comprising manganese-bearing oxide minerals are the same ore. In another aspect, the ore comprising iron oxides and the ore comprising manganese-bearing oxide minerals are different ores. In another aspect, the food source comprises sugars, organic acids, water, or combinations thereof. In another aspect, the food source is derived from natural biomass. In another aspect, the natural biomass comprises decomposing cattail (Typha latifolia). In another aspect, the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof. In another aspect, the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof. In another aspect, the system operates in situ at the natural site of the ore comprising manganese-bearing oxide minerals. In another aspect, the system does not operate in situ at the natural site of the ore comprising manganese-bearing oxide minerals. In another aspect, the system operates in situ at the natural site of the ore comprising iron oxides. In another aspect, the system does not operate in situ at the natural site of the ore comprising iron oxides.

This disclosure provides for other aspects and embodiments that will be apparent in light of the following detailed description and accompanying figures.

### DESCRIPTION OF THE DRAWINGS

FIG. 1 shows a Pourbaix diagram for iron and manganese in water.

FIG. 2 shows a Pourbaix diagram for iron and manganese in solution, in equilibrium with 1 atmosphere carbon dioxide.

FIG. 3 shows a basic schematic of a two-stage leaching process using metal-reducing microorganisms and iron to selectively extract dissolved manganese. This exemplary two-stage leaching process uses separate iron ore and manganese ore sources. Over time, iron dissolves from the first vessel and reprecipitates in the second vessel, replacing the manganese as it dissolves.

FIG. 4 shows a schematic of a concentration gradient between two stages of leaching, taking advantage of iron that is naturally present in the manganese ore. Thus, this exemplary two-stage leaching process uses an ore containing both iron and manganese. The interface between the Stage 1 region and the Stage 2 region moves down over time as manganese oxides are dissolved and replaced by iron oxides.

FIG. 5 shows a schematic of an exemplary large-scale leaching configuration for manganese-bearing ore in a flooded impoundment. This configuration could include an artificial tailings pond, a mined-out open pit mine, or a natural manganese-rich deposit that is near the surface and permeable to water.

FIG. 6 shows a schematic of an exemplary large-scale heap leaching configuration for manganese-bearing ore stacked on a geotextile pad or other water-impermeable surface.

FIG. 7 shows different experimental setups for exemplary two-stage manganese leaching processes with an iron assist. Three different experiments are shown. The upper flasks contain iron ore, while the lower flasks contain a separate manganese ore, with additional smaller flasks present to collect any overflow solution when fresh media is injected.

FIG. 8 shows a graph of the dissolved iron concentration in the iron ore flask and manganese ore flask over time for the Experiment 1 setup of the two-stage leaching process in Example 1.

FIG. 9 shows a graph of the dissolved manganese concentration in the solution leaving the manganese ore flask over time for the Experiment 1 setup of the two-stage leaching process in Example 1.

FIG. 10 shows a graph of the total cumulative manganese dissolved over time using iron assist for the Experiment 1 setup of the two-stage leaching process in Example 1.

FIG. 11 shows a graph of the dissolved iron concentration in the iron ore flask and manganese ore flask for the Experiment 2 setup of the two-stage leaching process in Example 1.

FIG. 12 shows a graph of the dissolved manganese concentration in the solution leaving the manganese ore flask over time for the Experiment 2 setup of the two-stage leaching process in Example 1.

FIG. 13 shows a graph of the total cumulative manganese dissolved over time using iron assist for the Experiment 2 setup of the two-stage leaching process in Example 1.

FIG. 14 shows a graph of the dissolved iron concentration in the iron ore flask and manganese ore flask for the Experiment 3 setup of the two-stage leaching process in Example 1.

FIG. 15 shows a graph of the dissolved manganese concentration in the solution leaving the manganese ore flask over time for the Experiment 3 setup of the two-stage leaching process in Example 1.

Before any embodiments of this disclosure are explained in detail, it is to be understood that the disclosure is not limited in its application to the details of construction and the arrangement of components set forth in the following description or illustrated in the accompanying figures. Also, it is to be understood that the phraseology and terminology used herein is for the purpose of description and should not be regarded as limiting.

### DETAILED DESCRIPTION

Described herein are various systems and methods for selectively leaching and extracting manganese from ores. In some embodiments, the systems and methods may use a solution comprising reduced iron to assist in the leaching and extraction of manganese. In some embodiments, the systems and methods may use dissimilatory metal-reducing microorganisms to assist in the leaching and extraction of manganese. In some embodiments, the systems and methods may use both reduced iron and dissimilatory metal-reducing microorganisms to assist in the leaching and extraction of manganese. The disclosed systems and methods provide safer, more environmentally friendly, and more cost-efficient means for selective manganese extraction compared to conventional methods.

One embodiment described herein is a method of selectively extracting manganese from an ore, the method comprising: incubating an ore comprising manganese-bearing oxide minerals with a solution comprising reduced iron for a period of time sufficient to generate soluble reduced manganese; wherein the reduced iron is precipitated as insoluble iron; and wherein a pH of the solution is maintained below about 5.5. Another embodiment described herein is a system for selectively extracting manganese from an ore, the system comprising: an ore comprising manganese-bearing oxide minerals; and a solution comprising reduced iron, wherein a pH of the solution is maintained below about 5.5.

Unless otherwise defined herein, all technical and scientific terms used in connection with the present disclosure have the same meaning as commonly understood by one of ordinary skill in the art. The meaning and scope of the terms should be clear. In case of conflict, the present document, including definitions, will control. Preferred methods and materials are described below, although methods and materials similar or equivalent to those described herein can be used in practice or testing of the present disclosure. Further, unless otherwise required by context, singular terms shall include pluralities and plural terms shall include the singular. All publications, patent applications, patents and other references mentioned herein are incorporated by reference in their entirety. The materials, methods, and examples disclosed herein are illustrative only and not intended to be limiting.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to +10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to +10% of any value within the range or within 3 or more standard deviations, including the end points.

As used herein, the terms “control,” or “reference” are used herein interchangeably. A “reference” or “control” level may be a predetermined value or range, which is employed as a baseline or benchmark against which to assess a measured result. “Control” also refers to control experiments or control conditions.

As used herein, an “ore” refers to a naturally occurring solid material from which a valuable mineral and/or metal (e.g., manganese) can be extracted. Ores are often mined or excavated from ore deposits, which comprise ore minerals containing the valuable substance. Examples of ore deposits include, but are not limited to, hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits, and astrobleme-related deposits. Ores, as defined herein, however, can also include ore concentrates or tailings, coal or coal waste products, or even other sources of metal or valuable minerals. In some embodiments of the present disclosure, the ore may be mined and crushed, micronized, pulverized, or ground into smaller particles for manganese extraction. In other embodiments, the ore may be in its natural unprocessed state (i.e., raw form) for manganese extraction. In some embodiments, the ore may be located at its natural site and is not mined or excavated (i.e., in situ). In some embodiments, the ore may be in the form of mine tailings, or the waste products left behind after a mineral has been separated from gangue. The disclosed systems and methods provide means for effective manganese extraction from various grades of ore, including “low grade” ores, which are metal ore deposits in which desired concentrated metals are either finely grown together or distributed in relatively low concentrations inside a complex ore.

As used herein, “dissimilatory metal-reducing microorganisms” or “metal-reducing microorganisms” refer to a group of microorganisms (e.g., bacteria, yeast, and/or fungi) that can perform anaerobic respiration utilizing a metal as a terminal electron acceptor rather than molecular oxygen (O₂). Some common metals and metalloids used by these microorganisms include iron [Fe(III)], manganese [Mn(IV)], vanadium [V(V)], chromium [Cr(VI)], molybdenum [Mo(VI)], cobalt [Co(III)], palladium [Pd(II)], gold [Au(III)], and mercury [Hg(II)], among others. Nonlimiting examples of metal-reducing microorganisms that are suitable for the disclosed systems and methods are described in Eisele and Gabby, “Review of reductive leaching of iron by anaerobic bacteria,” Mineral Processing and Extractive Metallurgy Review 35 (2): pp. 75-105 (2014), the entire contents of which is hereby incorporated by reference into the specification.

In some embodiments of the present disclosure, an ore comprising manganese-bearing oxide minerals (e.g., MnO₂) and/or iron oxides may be combined and incubated with a culture of one or more dissimilatory metal-reducing microorganisms comprising anaerobic bacteria selected from Bacillus, Geobacter, Shewanella, Acidithiobacillus, Desulfuromonas, Desulfovibrio, Acidiphilium, Acidocella, Acidobacterium, Ferroplasma, Sulfobacillus, Ferrimicrobium, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof. In certain nonlimiting embodiments, the culture of one or more dissimilatory metal-reducing microorganisms may comprise anaerobic bacteria selected from the species of Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof.

These disclosed metal-reducing microorganisms typically rely on simple organic compounds including sugars and organic acids as a food source in the disclosed systems and methods. In some embodiments, the organic compounds that are used as a food source and metabolized by the metal-reducing microorganisms can be produced by the decomposition of natural biomass, making it unnecessary to utilize any additional manufactured reagents or potentially toxic materials in the disclosed leaching and extraction operations. As disclosed herein, one nonlimiting exemplary food source for the metal-reducing microorganisms includes a natural biomass comprising decomposing cattail (Typha latifolia) that may be present on or near the site of an ore. Other suitable food sources may include, but are not limited to, sugars, organic acids, water, combinations thereof, and the like. Therefore, the disclosed systems and methods may be entirely fueled by natural biomass including, but not limited to, decomposing/rotting cattails or other wetland plants that can produce the necessary organic compounds for the metal-reducing microorganisms to function and react with the metals.

The disclosed dissimilatory metal-reducing microorganisms are capable of reducing and dissolving metals such as iron and manganese from an ore by using the metals as a terminal electron acceptor, as the microorganisms metabolize simple organic compounds in an anerobic environment, such as in the following reduction reactions:

$$\begin{matrix}{C}_{x} {H}_{y} {O}_{z} + F {e}^{3 +} \to C {O}_{2} + {H}_{2} O + F {e}^{2 +} \\ {C}_{x} {H}_{y} {O}_{z} + M {n}^{4 +} / {Mn}^{3 +} \to C {O}_{2} + {H}_{2} O + M {n}^{2 +} .\end{matrix}$$

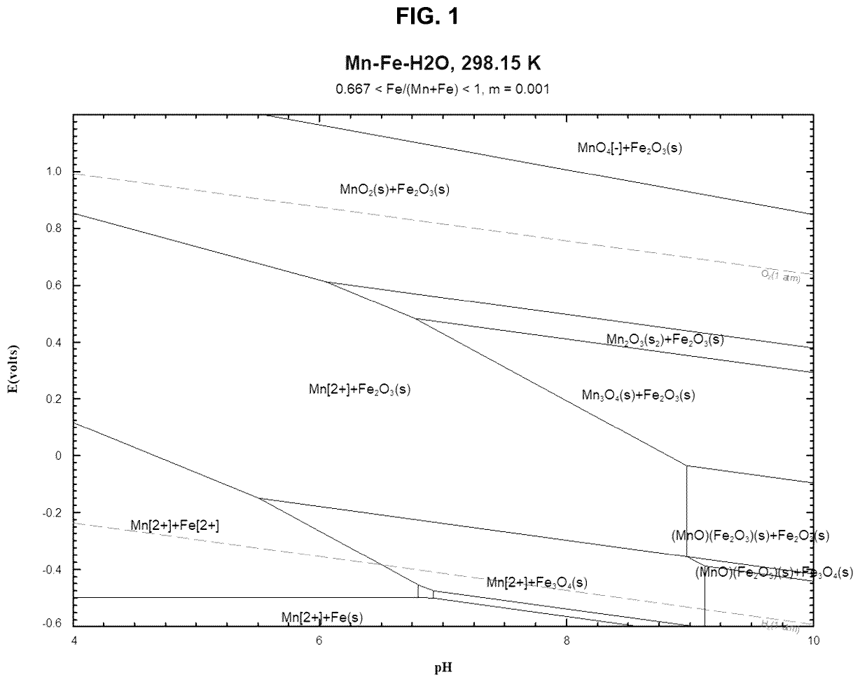

This anaerobic reductice bioleaching process is described in Sharma and Eisele, “Anaerobic reductive bioleaching of manganese ores,” Minerals Engineering 173: p. 107152 (2021), the entire contents of which is hereby incorporated by reference into the specification. By converting the metals of iron and manganese to the more-reduced 2+ state, it dramatically increases their solubilities even at moderate pH values, as can be seen in the Pourbaix diagram of FIG. 1. As disclosed herein, it is possible to dissolve the manganese selectively by keeping the pH and redox conditions within the large Mn²⁺+Fe₂O₃ (s) phase field (FIG. 1), where the manganese reduces and dissolves, and the iron remains as a solid oxide. This then allows manganese to be dissolved as soluble reduced manganese without the use of harsh mineral acids. Thus, one advantage of the disclosed systems and methods is that the dissimilatory metal-reducing microorganisms are able to directly reduce the manganese and/or iron as part of their respiration, and they are not simply producing a generally reducing environment of sufficient acidity for the manganese and/or to eventually dissolve. As a result, the pH of the leaching solution does not need to be strongly acidic, allowing for the selective dissolution of manganese while precipitating iron.

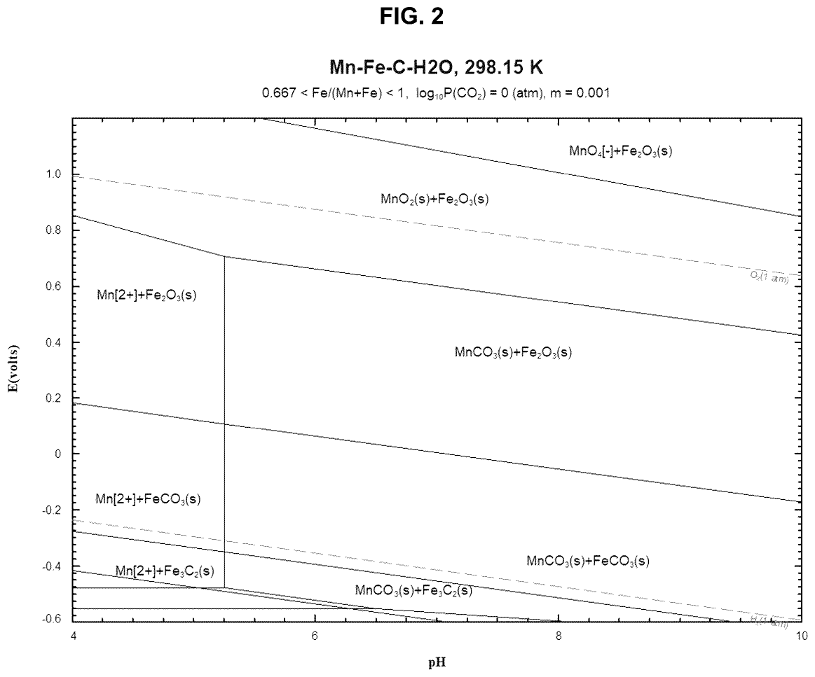

The disclosed leaching and extraction of manganese from ore may be compromised if there is carbon dioxide in solution, as the carbon dioxide can react with soluble reduced manganese (e.g., dissolved Mn²⁺) to produce undesirable insoluble manganese carbonate, as can be seen in the Pourbaix diagram of FIG. 2. In order to keep the manganese in solution, the pH of a leaching solution is typically kept more acidic than about pH 5.5 (e.g., pH≤5.0). Thus, another particular advantage of the disclosed systems and methods is that very small levels of manganese carbonate, if any, are generated because the process of dissolving manganese is separated from any processes that form carbon dioxide, thereby minimizing or eliminating any contact between manganese and carbonate ions. In some embodiments, the disclosed systems and methods are capable of extracting a manganese product that is essentially free of manganese carbonate. As defined herein, the term “essentially free” generally means an amount that is less than about 10.0% by weight, or less than about 5.0% by weight, such as less than about 4.0% by weight, less than about 3.0% by weight, less than about 2.0% by weight, less than about 1.0% by weight, less than about 0.50% by weight, less than about 0.10% by weight, less than about 0.05% by weight, less than about 0.01% by weight, less than about 0.005% by weight, less than about 0.001% by weight, less than about 0.0005% by weight, or less than about 0.0001% by weight of the total extracted manganese product. In some embodiments, the disclosed systems and methods do not generate any manganese carbonate. For example, one embodiment described herein is a method of selectively extracting manganese from an ore, where the ore is incubated with a solution comprising reduced iron to generate soluble reduced manganese in the absence of any carbon dioxide that could react with the soluble reduced manganese to form manganese carbonate.

In some embodiments, the disclosed systems and methods may comprise a solution comprising reduced iron, wherein a pH of the solution is maintained below about 5.5. In some embodiments, the pH of the solution may be maintained at or below about 5.4, at or below about 5.3, at or below about 5.2, at or below about 5.1, at or below about 5.0, at or below about 4.9, at or below about 4.8, at or below about 4.7, at or below about 4.6, at or below about 4.5, at or below about 4.4, at or below about 4.3, at or below about 4.2, at or below about 4.1, or at or below about 4.0. In some embodiments, the pH of the solution may be less than about 4.0. In some embodiments, the pH of the solution may be maintained from about 4.0 to about 5.5. In some embodiments, the pH of the solution may be maintained at no greater than about 5.5. In some embodiments, the pH of the solution may be maintained at no less than about 4.0. In some embodiments, the solution may further comprise one or more pH modulating agents including, but not limited to, potassium hydroxide, ammonium hydroxide, potassium carbonate or bicarbonate, hydrochloric acid, nitric acid, sulfuric acid, or a mixture thereof. In some embodiments, the disclosed systems and methods may comprise a constant pH for the leaching solution. In other embodiments, the disclosed systems and methods may comprise a variable pH for the leaching solution.

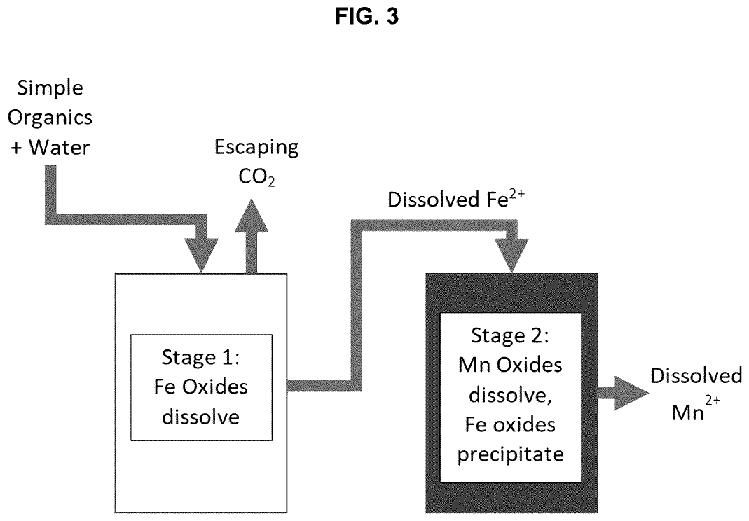

While it is possible to selectively extract manganese from ore in a single dissolution step using dissimilatory metal-reducing microorganisms at a pH below about 5.0 to prevent manganese carbonate formation, it is also beneficial to take advantage of any iron present in the manganese ore itself, or present in another independent ore, by carrying out a two-stage leaching process. By performing such a two-stage leaching process, such as the exemplary configuration shown in FIG. 3 that uses separate iron ore and manganese ore sources, the incubation of the iron oxides with the microorganisms in Stage 1 results in a solution of dissolved Fe²⁺, while the carbon dioxide is allowed to escape. The Fe²⁺ solution then contacts the manganese oxides in Stage 2, where the organic material used by the microorganisms has been depleted, so no additional carbon dioxide is generated. In Stage 2, any reduced iron (Fe²⁺) that comes into contact with minerals that contain either Mn⁴⁺ or Mn³⁺ will reduce these to Mn²⁺, with the iron being oxidized and precipitating as Fe₂O₃ or FeOOH, according to the following reactions:

$$\begin{matrix}M {n}_{2} {O}_{3} + 2 F {e}^{2 +} \to F {e}_{2} {O}_{3} + 2 M {n}^{2 +} \\ Mn {O}_{2} + 2 F {e}^{2 +} + 2 {H}_{2} O \to 2 FeOOH + {Mn}^{2 +} + 2 {H}^{+} .\end{matrix}$$

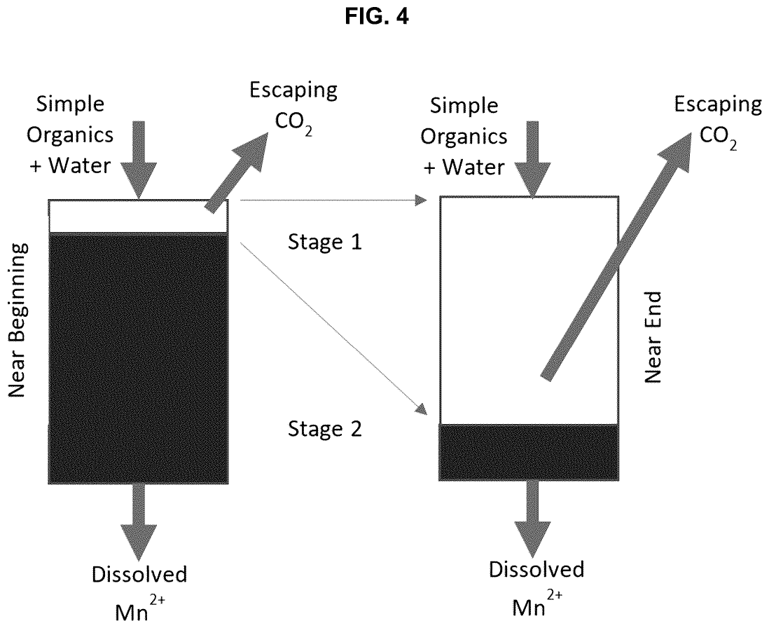

In comparison, if a single ore containing both iron and manganese is directionally incubated with the metal-reducing microorganisms, it is possible to perform a two-stage leaching process using a gradient as shown in FIG. 4. In the two-stage exemplary configuration of FIG. 4, there is no solid demarcation between Stage 1 and Stage 2. Instead, the volume occupied by Stage 1 gradually increases over time as the portion of the ore undergoing Stage 2 is depleted of manganese.

The disclosed systems and methods for manganese extraction may be implemented in any of several ways, depending on the nature of the ore material being processed and the specific needs of the user. In some embodiments of the present disclosure, manganese may be extracted from ore using one or more of a tank, flask, vat, leaching column, pool, or the like, in order to introduce a leaching solution and/or metal-reducing microorganisms to the ore. In certain embodiments, an ore comprising manganese-bearing oxide minerals is incubated with a leaching solution comprising reduced iron for a period of time sufficient to generate soluble reduced manganese and precipitated insoluble iron. This combination of the solution comprising reduced iron and the ore comprising manganese-bearing oxide minerals may be left for any amount of time sufficient to leach and extract the valuable manganese from the ore. In some embodiments, the period of time sufficient to generate the soluble reduced manganese ranges from about 1 day to about 6 months. In some embodiments, the period of time may be less than about 1 day. For example, the period of time may range from about 1 hour to about 23 hours for sufficient manganese extraction from the ore. In some embodiments, the period of time may be greater than about 6 months. For example, the period of time may be about 7 months or greater, about 8 months or greater, about 9 months or greater, about 12 months or greater, about 18 months or greater, or about 24 months or greater for sufficient manganese extraction from the ore. In some embodiments, the period of time may range from about 1 day to about 30 days, about 1 day to about 2 months, about 1 day to about 3 months, about 1 day to about 4 months, about 1 day to about 5 months, about 30 days to about 2 months, about 30 days to about 3 months, about 30 days to about 4 months, about 30 days to about 5 months, about 30 days to about 6 months, about 2 months to about 3 months, about 2 months to about 4 months, about 2 months to about 5 months, about 2 months to about 6 months, about 3 months to about 4 months, about 3 months to about 5 months, about 3 months to about 6 months, about 4 months to about 5 months, about 4 months to about 6 months, about 5 months to about 6 months, or even greater.

In some embodiments, the solution comprising reduced iron may optionally be mixed, agitated, flowed and/or circulated continuously (e.g., mechanically or using aeration) with the ore comprising manganese-bearing oxide minerals and throughout the leaching process time period to ensure that maximum and continuous contact is made between the solution and the ore. In some embodiments, the solution comprising reduced iron may optionally be applied to the ore comprising manganese-bearing oxide minerals at a particular flow rate throughout the leaching process time period to ensure that maximum and continuous contact is made between the solution and the ore. In certain embodiments, the solution may be applied to the ore at a flow rate ranging from about 10 L/metric ton ore/day to about 300 L/metric ton ore/day. In some embodiments, the flow rate may be less than about 10 L/metric ton ore/day. In some embodiments, the flow rate may be greater than about 300 L/metric ton ore/day. In some embodiments, the flow rate may range from about 10 L/metric ton ore/day to about 50 L/metric ton ore/day, about 10 L/metric ton ore/day to about 100 L/metric ton ore/day, about 10 L/metric ton ore/day to about 150 L/metric ton ore/day, about 10 L/metric ton ore/day to about 200 L/metric ton ore/day, about 10 L/metric ton ore/day to about 250 L/metric ton ore/day, about 50 L/metric ton ore/day to about 100 L/metric ton ore/day, about 50 L/metric ton ore/day to about 150 L/metric ton ore/day, about 50 L/metric ton ore/day to about 200 L/metric ton ore/day, about 50 L/metric ton ore/day to about 250 L/metric ton ore/day, about 50 L/metric ton ore/day to about 300 L/metric ton ore/day, about 100 L/metric ton ore/day to about 150 L/metric ton ore/day, about 100 L/metric ton ore/day to about 200 L/metric ton ore/day, about 100 L/metric ton ore/day to about 250 L/metric ton ore/day, about 100 L/metric ton ore/day to about 300 L/metric ton ore/day, about 150 L/metric ton ore/day to about 200 L/metric ton ore/day, about 150 L/metric ton ore/day to about 250 L/metric ton ore/day, about 150 L/metric ton ore/day to about 300 L/metric ton ore/day, about 200 L/metric ton ore/day to about 250 L/metric ton ore/day, about 200 L/metric ton ore/day to about 300 L/metric ton ore/day, or about 250 L/metric ton ore/day to about 300 L/metric ton ore/day. In some embodiments, the specific flow rate of solution may be dependent on the total size/amount of ore. In some embodiments, the disclosed systems and methods may comprise a constant flow rate of solution with ore. In other embodiments, the disclosed systems and methods may comprise a variable flow rate of solution with ore.

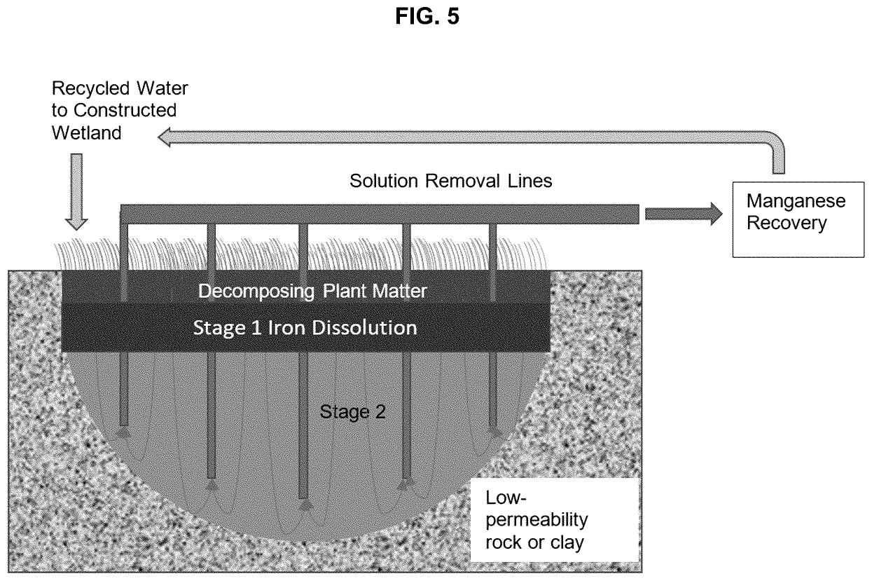

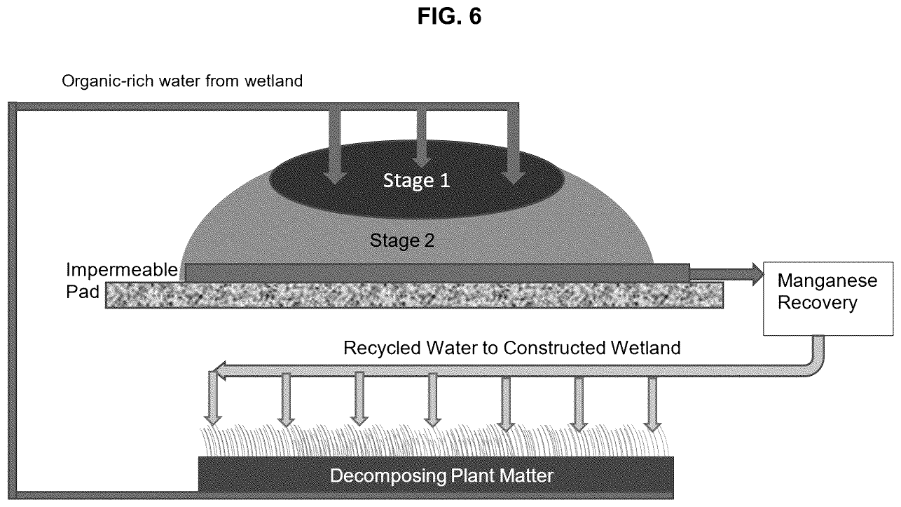

The disclosed systems and methods may be implemented in large-scale leaching operations. For example, if manganese-bearing ore has been excavated and placed in a tailings impoundment with an impermeable containment layer (i.e., artificial liner or low permeability rock or clay), organic-rich water can then be provided by growing wetland plants directly on top of the ore, as shown in FIG. 5. The organic-rich water will then percolate down into the ore, dissolve manganese as it is reduced by microorganisms, and can then be pumped back to the surface for manganese extraction using techniques known in the art. As another example, if the ore has been excavated and placed in heaps on a water-retaining geotextile pad, then a wetland can be constructed adjacent to the heap, as shown in FIG. 6. Organic-rich water can then be pumped to the top of the heap, percolate down through it, and then flow by gravity into the manganese leaching system. These large-scale leaching operations may use acidic leaching solutions (e.g., pH<5.5) comprising reduced iron (Fe²⁺) to extract the manganese, with or without the use of metal-reducing microorganisms to generate the soluble reduced manganese. In some embodiments, metal-reducing microorganisms may be used to generate the acidic leaching solution comprising reduced iron. In other embodiments, the acidic leaching solution comprising reduced iron is not generated from metal-reducing microorganisms.

In some embodiments, the disclosed systems and methods may comprise a temperature ranging from about 0° C. to about 35° C. for the extraction of manganese from ore. In some embodiments, the temperature may be less than about 0° C. In some embodiments, the temperature may be greater than about 35° C. In some embodiments, the temperature may range from about 0° C. to about 5° C., about 0° C. to about 10° C., about 0° C. to about 15° C., about 0° C. to about 20° C., about 0° C. to about 25° C., about 0° C. to about 30° C., about 5° C. to about 10° C., about 5° C. to about 15° C., about 5° C. to about 20° C., about 5° C. to about 25° C., about 5° C. to about 30° C., about 5° C. to about 35° C., about 10° C. to about 15° C., about 10° C. to about 20° C., about 10° C. to about 25° C., about 10° C. to about 30° C., about 10° C. to about 35° C., about 15° C. to about 20° C., about 15° C. to about 25° C., about 15° C. to about 30° C., about 15° C. to about 35° C., about 20° C. to about 25° C., about 20° C. to about 30° C., about 20° C. to about 35° C., about 25° C. to about 30° C., about 25° C. to about 35° C., or about 30° C. to about 35° C. In some embodiments, the disclosed systems and methods may comprise a constant temperature. In other embodiments, the disclosed systems and methods may comprise a variable temperature.

In some embodiments, the disclosed systems and methods may comprise a pressure ranging from about 1 atm to about 100 atm for the extraction of manganese from ore. In some embodiments, the pressure may be less than about 1 atm. In some embodiments, the pressure may be greater than about 100 atm. In some embodiments, the pressure may range from about 1 atm to about 5 atm, about 1 atm to about 10 atm, about 1 atm to about 20 atm, about 1 atm to about 25 atm, about 1 atm to about 40 atm, about 1 atm to about 50 atm, about 1 atm to about 60 atm, about 1 atm to about 75 atm, about 1 atm to about 80 atm, about 1 atm to about 90 atm, about 1 atm to about 95 atm, about 5 atm to about 10 atm, about 5 atm to about 20 atm, about 5 atm to about 25 atm, about 5 atm to about 40 atm, about 5 atm to about 50 atm, about 5 atm to about 60 atm, about 5 atm to about 75 atm, about 5 atm to about 80 atm, about 5 atm to about 90 atm, about 5 atm to about 95 atm, about 5 atm to about 100 atm, about 10 atm to about 20 atm, about 10 atm to about 25 atm, about 10 atm to about 40 atm, about 10 atm to about 50 atm, about 10 atm to about 60 atm, about 10 atm to about 75 atm, about 10 atm to about 80 atm, about 10 atm to about 90 atm, about 10 atm to about 95 atm, about 10 atm to about 100 atm, about 20 atm to about 25 atm, about 20 atm to about 40 atm, about 20 atm to about 50 atm, about 20 atm to about 60 atm, about 20 atm to about 75 atm, about 20 atm to about 80 atm, about 20 atm to about 90 atm, about 20 atm to about 95 atm, about 20 atm to about 100 atm, about 25 atm to about 40 atm, about 25 atm to about 50 atm, about 25 atm to about 60 atm, about 25 atm to about 75 atm, about 25 atm to about 80 atm, about 25 atm to about 90 atm, about 25 atm to about 95 atm, about 25 atm to about 100 atm, about 40 atm to about 50 atm, about 40 atm to about 60 atm, about 40 atm to about 75 atm, about 40 atm to about 80 atm, about 40 atm to about 90 atm, about 40 atm to about 95 atm, about 40 atm to about 100 atm, about 50 atm to about 60 atm, about 50 atm to about 75 atm, about 50 atm to about 80 atm, about 50 atm to about 90 atm, about 50 atm to about 95 atm, about 50 atm to about 100 atm, about 60 atm to about 75 atm, about 60 atm to about 80 atm, about 60 atm to about 90 atm, about 60 atm to about 95 atm, about 60 atm to about 100 atm, about 75 atm to about 80 atm, about 75 atm to about 90 atm, about 75 atm to about 95 atm, about 75 atm to about 100 atm, about 80 atm to about 90 atm, about 80 atm to about 95 atm, about 80 atm to about 100 atm, about 90 atm to about 95 atm, about 90 atm to about 100 atm, or about 95 atm to about 100 atm. In some embodiments, the disclosed systems and methods may comprise a constant pressure. In other embodiments, the disclosed systems and methods may comprise a variable pressure.

The specific temperature and pressure parameters of the disclosed systems and methods that are required for effective extraction of manganese from ore will depend on the specific environmental conditions and location where the manganese is to be extracted from the ore. For example, in some embodiments, the disclosed methods are performed, or the disclosed systems are operated, in situ at a natural site of an ore comprising manganese-bearing oxide minerals (i.e., the ore is not excavated from its natural site), such as the configurations shown in FIG. 5-6. In other embodiments, the disclosed methods are not performed, or the disclosed systems are not operated, in situ at the natural site of the ore comprising manganese-bearing oxide minerals (i.e., the ore is excavated from its natural site and treated elsewhere). For in situ leaching operations where the ore is not excavated from its natural site, the pressure will typically be much higher because the non-excavated ore body containing the manganese may be up to several hundred feet beneath the surface. In some embodiments, the disclosed systems ad methods can be carried out and operated at atmospheric pressure and lower temperatures than conventional techniques. Thus, the systems and methods disclosed herein may not require complicated equipment or high energy consumption.

One embodiment described herein is a method of selectively extracting manganese from an ore, the method comprising: incubating an ore comprising manganese-bearing oxide minerals with a solution comprising reduced iron for a period of time sufficient to generate soluble reduced manganese; wherein the reduced iron is precipitated as insoluble iron; and wherein a pH of the solution is maintained below about 5.5. In one aspect, the method does not generate manganese carbonate. In another aspect, the manganese-bearing oxide minerals are Mn₂O₃, MnO₂, hydrated manganese oxides, or combinations thereof. In another aspect, the soluble reduced manganese is dissolved Mn²⁺. In another aspect, the reduced iron is dissolved ferrous iron (Fe²⁺). In another aspect, the insoluble iron is Fe₂O₃, FeOOH, Fe(OH)₃, or combinations thereof. In another aspect, the pH of the solution is maintained from about 4.0 to about 5.5. In another aspect, the period of time sufficient to generate the soluble reduced manganese and the insoluble iron ranges from about 1 day to about 6 months. In another aspect, the method is performed at a temperature ranging from about 0° C. to about 35° C. In another aspect, the method is performed at a pressure ranging from about 1 atm to about 100 atm. In another aspect, the solution comprising reduced iron is first generated by incubating an ore comprising iron oxides with one or more dissimilatory metal-reducing microorganisms and a food source to generate reduced iron and carbon dioxide in the solution, and allowing the carbon dioxide to release from the solution. In another aspect, the ore comprising iron oxides comprises only iron oxides. In another aspect, the ore comprising iron oxides and the ore comprising manganese-bearing oxide minerals are the same ore. In another aspect, the ore comprising iron oxides and the ore comprising manganese-bearing oxide minerals are different ores. In another aspect, the food source comprises sugars, organic acids, water, or combinations thereof. In another aspect, the food source is derived from natural biomass. In another aspect, the natural biomass comprises decomposing cattail (Typha latifolia). In another aspect, the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof. In another aspect, the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof. In another aspect, the method is performed in situ at the natural site of the ore comprising manganese-bearing oxide minerals. In another aspect, the method is not performed in situ at the natural site of the ore comprising manganese-bearing oxide minerals. In another aspect, the method is performed in situ at the natural site of the ore comprising iron oxides. In another aspect, the method is not performed in situ at the natural site of the ore comprising iron oxides.

Another embodiment described herein is a system for selectively extracting manganese from an ore, the system comprising: an ore comprising manganese-bearing oxide minerals; and a solution comprising reduced iron, wherein a pH of the solution is maintained below about 5.5. In one aspect, the system does not generate manganese carbonate. In another aspect, the manganese-bearing oxide minerals are Mn₂O₃, MnO₂, hydrated manganese oxides, or combinations thereof. In another aspect, the system generates soluble reduced manganese. In another aspect, the reduced iron is precipitated as insoluble iron when the soluble reduced manganese is generated. In another aspect, the soluble reduced manganese is dissolved Mn²⁺. In another aspect, the reduced iron is dissolved ferrous iron (Fe²⁺). In another aspect, the insoluble iron is Fe₂O₃, FeOOH, Fe(OH)₃, or combinations thereof. In another aspect, the pH of the solution is maintained from about 4.0 to about 5.5. In another aspect, the system operates at a temperature ranging from about 0° C. to about 35° C. In another aspect, the system operates at a pressure ranging from about 1 atm to about 100 atm. In another aspect, the solution comprising reduced iron is generated by incubating an ore comprising iron oxides with one or more dissimilatory metal-reducing microorganisms and a food source to generate reduced iron and carbon dioxide in the solution, wherein the carbon dioxide is released from the solution. In another aspect, the ore comprising iron oxides comprises only iron oxides. In another aspect, the ore comprising iron oxides and the ore comprising manganese-bearing oxide minerals are the same ore. In another aspect, the ore comprising iron oxides and the ore comprising manganese-bearing oxide minerals are different ores. In another aspect, the food source comprises sugars, organic acids, water, or combinations thereof. In another aspect, the food source is derived from natural biomass. In another aspect, the natural biomass comprises decomposing cattail (Typha latifolia). In another aspect, the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof. In another aspect, the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof. In another aspect, the system operates in situ at the natural site of the ore comprising manganese-bearing oxide minerals. In another aspect, the system does not operate in situ at the natural site of the ore comprising manganese-bearing oxide minerals. In another aspect, the system operates in situ at the natural site of the ore comprising iron oxides. In another aspect, the system does not operate in situ at the natural site of the ore comprising iron oxides.

It will be apparent to one of ordinary skill in the relevant art that suitable modifications and adaptations to the compositions, systems, methods, processes, and applications described herein can be made without departing from the scope of any embodiments or aspects thereof. The systems and methods provided are exemplary and are not intended to limit the scope of any of the specified embodiments. All of the various embodiments, aspects, and options disclosed herein can be combined in any variations or iterations. The scope of the compositions, systems, methods, processes, and applications described herein include all actual or potential combinations of embodiments, aspects, options, examples, and preferences herein described. The exemplary systems and methods described herein may omit any component, substitute any component disclosed herein, or include any component disclosed elsewhere herein. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. A method of selectively extracting manganese from an ore, the method comprising:
   incubating an ore comprising manganese-bearing oxide minerals with a solution comprising reduced iron for a period of time sufficient to generate soluble reduced manganese;
      wherein the reduced iron is precipitated as insoluble iron; and
      wherein a pH of the solution is maintained below about 5.5.
Clause 2. The method of clause 1, wherein the method does not generate manganese carbonate.
Clause 3. The method of clause 1 or 2, wherein the manganese-bearing oxide minerals are Mn₂O₃, MnO₂, hydrated manganese oxides, or combinations thereof.
Clause 4. The method of any one of clauses 1-3, wherein the soluble reduced manganese is dissolved Mn²⁺.
Clause 5. The method of any one of clauses 1-4, wherein the reduced iron is dissolved ferrous iron (Fe²⁺).
Clause 6. The method of any one of clauses 1-5, wherein the insoluble iron is Fe₂O₃, FeOOH, Fe(OH)₃, or combinations thereof.
Clause 7. The method of any one of clauses 1-6, wherein the pH of the solution is maintained from about 4.0 to about 5.5.
Clause 8. The method of any one of clauses 1-7, wherein the period of time sufficient to generate the soluble reduced manganese and the insoluble iron ranges from about 1 day to about 6 months.
Clause 9. The method of any one of clauses 1-8, wherein the method is performed at a temperature ranging from about 0° C. to about 35° C.
Clause 10. The method of any one of clauses 1-9, wherein the method is performed at a pressure ranging from about 1 atm to about 100 atm.
Clause 11. The method of any one of clauses 1-10, wherein the solution comprising reduced iron is first generated by incubating an ore comprising iron oxides with one or more dissimilatory metal-reducing microorganisms and a food source to generate reduced iron and carbon dioxide in the solution, and allowing the carbon dioxide to release from the solution.
Clause 12. The method of clause 11, wherein the ore comprising iron oxides comprises only iron oxides.
Clause 13. The method of clause 11 or 12, wherein the ore comprising iron oxides and the ore comprising manganese-bearing oxide minerals are the same ore.
Clause 14. The method of clause 11 or 12, wherein the ore comprising iron oxides and the ore comprising manganese-bearing oxide minerals are different ores.
Clause 15. The method of any one of clauses 11-14, wherein the food source comprises sugars, organic acids, water, or combinations thereof.
Clause 16. The method of any one of clauses 11-15, wherein the food source is derived from natural biomass.
Clause 17. The method of clause 16, wherein the natural biomass comprises decomposing cattail (Typha latifolia).
Clause 18. The method of any one of clauses 11-17, wherein the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof.
Clause 19. The method of any one of clauses 11-18, wherein the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof.
Clause 20. The method of any one of clauses 1-19, wherein the method is performed in situ at the natural site of the ore comprising manganese-bearing oxide minerals.
Clause 21. The method of any one of clauses 1-19, wherein the method is not performed in situ at the natural site of the ore comprising manganese-bearing oxide minerals.
Clause 22. The method of any one of clauses 11-19, wherein the method is performed in situ at the natural site of the ore comprising iron oxides.
Clause 23. The method of any one of clauses 11-19, wherein the method is not performed in situ at the natural site of the ore comprising iron oxides.
Clause 24. A system for selectively extracting manganese from an ore, the system comprising: an ore comprising manganese-bearing oxide minerals; and a solution comprising reduced iron, wherein a pH of the solution is maintained below about 5.5.
Clause 25. The system of clause 24, wherein the system does not generate manganese carbonate.
Clause 26. The system of clause 24 or 25, wherein the manganese-bearing oxide minerals are Mn₂O₃, MnO₂, hydrated manganese oxides, or combinations thereof.
Clause 27. The system of any one of clauses 24-26, wherein the system generates soluble reduced manganese.
Clause 28. The system of clause 27, wherein the reduced iron is precipitated as insoluble iron when the soluble reduced manganese is generated.
Clause 29. The system of clause 27 or 28, wherein the soluble reduced manganese is dissolved Mn²⁺.
Clause 30. The system of any one of clauses 24-29, wherein the reduced iron is dissolved ferrous iron (Fe²⁺).
Clause 31. The system of any one of clauses 28-30, wherein the insoluble iron is Fe₂O₃, FeOOH, Fe(OH)₃, or combinations thereof.
Clause 32. The system of any one of clauses 24-31, wherein the pH of the solution is maintained from about 4.0 to about 5.5.
Clause 33. The system of any one of clauses 24-32, wherein the system operates at a temperature ranging from about 0° C. to about 35° C.
Clause 34. The system of any one of clauses 24-33, wherein the system operates at a pressure ranging from about 1 atm to about 100 atm.
Clause 35. The system of any one of clauses 24-34, wherein the solution comprising reduced iron is generated by incubating an ore comprising iron oxides with one or more dissimilatory metal-reducing microorganisms and a food source to generate reduced iron and carbon dioxide in the solution, wherein the carbon dioxide is released from the solution.
Clause 36. The system of clause 35, wherein the ore comprising iron oxides comprises only iron oxides.
Clause 37. The system of clause 35 or 36, wherein the ore comprising iron oxides and the ore comprising manganese-bearing oxide minerals are the same ore.
Clause 38. The system of clause 35 or 36, wherein the ore comprising iron oxides and the ore comprising manganese-bearing oxide minerals are different ores.
Clause 39. The system of any one of clauses 35-38, wherein the food source comprises sugars, organic acids, water, or combinations thereof.
Clause 40. The system of any one of clauses 35-39, wherein the food source is derived from natural biomass.
Clause 41. The system of clause 40, wherein the natural biomass comprises decomposing cattail (Typha latifolia).
Clause 42. The system of any one of clauses 35-41, wherein the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof.
Clause 43. The system of any one of clauses 35-42, wherein the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof.
Clause 44. The system of any one of clauses 24-43, wherein the system operates in situ at the natural site of the ore comprising manganese-bearing oxide minerals.
Clause 45. The system of any one of clauses 24-43, wherein the system does not operate in situ at the natural site of the ore comprising manganese-bearing oxide minerals.
Clause 46. The system of any one of clauses 35-43, wherein the system operates in situ at the natural site of the ore comprising iron oxides.
Clause 47. The system of any one of clauses 35-43, wherein the system does not operate in situ at the natural site of the ore comprising iron oxides.

### EXAMPLES

### Example 1

Two-Stage Leaching Process with Metal-Reducing Microorganisms

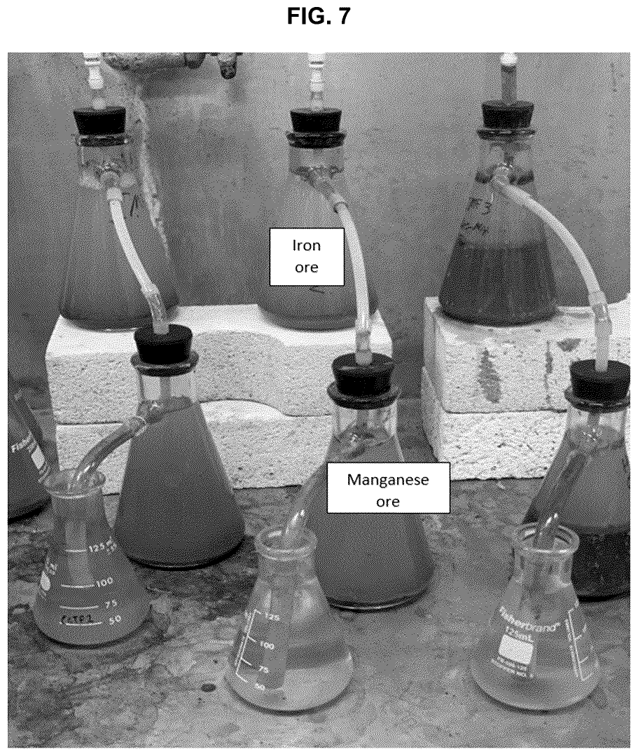

Experiments were conducted to evaluate the performance of two-stage leaching processes using 250 mL side-arm flasks as the leaching vessels. These two-stage leaching processes prevent manganese carbonate formation by separating the stage of the process where carbon dioxide is generated from the stage where manganese is dissolved, preventing them from reacting with each other. The setup for three different two-stage leaching experiments is shown in FIG. 7.

The experiments used flow rates of leaching solution that were as high as about 60 mL/day, corresponding to a larger-scale flow rate of about 200 L/metric ton ore/day. Lower flow rates of the leaching solution (e.g., corresponding to about 30 L/metric ton ore/day) have also been tested, based on the total amount of ore present in the leaching vessel.

Iron-Manganese Two-Stage Leaching Flask Experiment 1 Setup. The Experiment 1 setup included only 10 grams of iron ore and manganese ore, as specified in Table 1. Both the iron ore flask and the manganese ore flask included a cattails nutrient media as a microorganism food source, but only the iron ore flask included a microorganism inoculant comprising a culture of dissimilatory metal-reducing anaerobic bacteria.

TABLE 1
Specifications for two-stage leaching Experiment 1 setup.
Specifications

| Iron ore flask (First flask) | 10 g Minnesota iron ore | |
|---|---|---|
| | Microorganism inoculant from a stock | |
| | solution | |
| | Cattails nutrient media | |
| Manganese ore flask | 10 g high-grade Copper Harbor ore | |
| (Second flask) | (80% MnO₂) | |
| | No microorganism inoculant | |
| | Cattails nutrient media | |
| Incubation period | 26 | days |
| Cattails media | 300 | mL/week |
| change frequency | | |

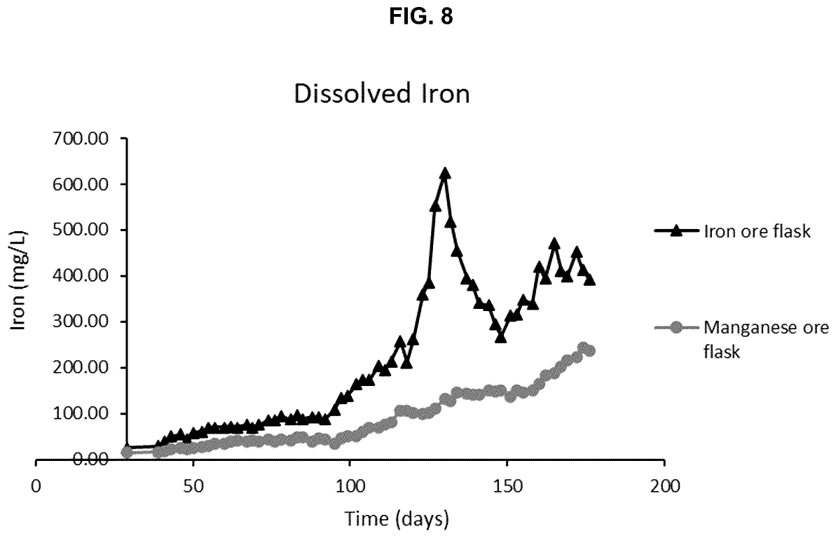

After an incubation period of 26 days, the first sample was collected for the analysis of manganese. Following 55 days of incubation, iron analysis was started. The pH of the overflow solution was observed in the range of pH 4-4.5. During the first 3 months of the experiment, the iron content of the solution coming out of the first flask was less than about 100 ppm (mg/L), and only about half of this iron was being removed in the second (manganese) flask. After 3 months, the iron content in the first flask began to rapidly increase, peaking at about 600 ppm before stabilizing at approximately 400 ppm, as shown in FIG. 8. The fraction of iron being precipitated in the manganese-leaching flask was still approximately 50%.

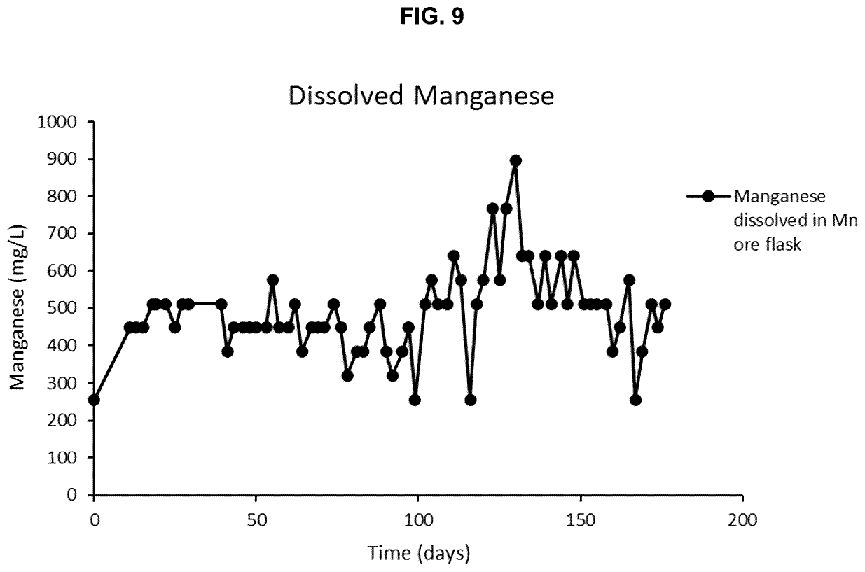

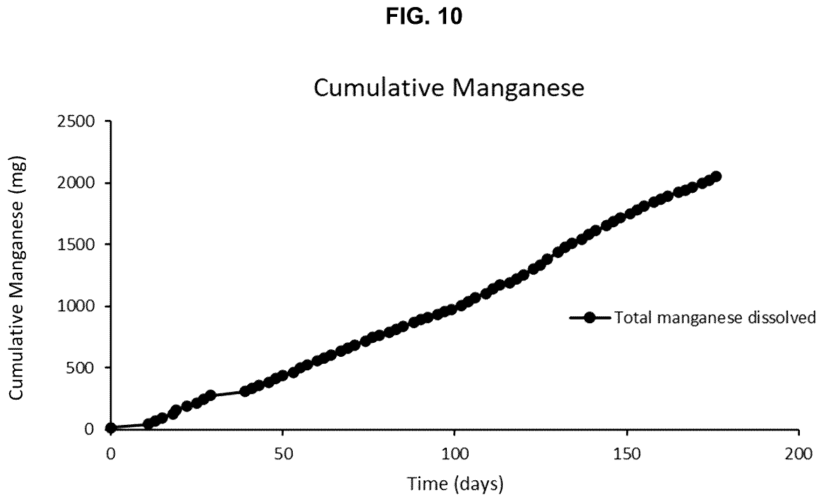

The concentration of manganese dissolved in the manganese ore flask is shown in FIG. 9, and the cumulative manganese dissolution is shown in FIG. 10. Manganese dissolved to a concentration of about 500 ppm, which was almost twice as much manganese being dissolved as there was iron being precipitated.

Iron-Manganese Two-Stage Leaching Flask Experiment 2 Setup. The Experiment 2 setup changed the specific microorganism inoculant and the iron ore to determine whether better results could be achieved as compared to the Experiment 1 setup. The quantities of iron ore and manganese ore were also increased from 10 grams to 25 grams, as shown in Table 2. Both the iron ore flask and the manganese ore flask included a cattails nutrient media as a microorganism food source, but only the iron ore flask included a microorganism inoculant comprising a culture of dissimilatory metal-reducing anaerobic bacteria.

TABLE 2
Specifications for two-stage leaching Experiment 2 setup.
Specifications

| Iron ore flask (First flask) | 25 g iron ore tailings | |
|---|---|---|
| | Microorganism inoculant from | |
| | anaerobic leaching flasks | |
| | Cattails nutrient media | |
| Manganese ore flask (Second flask) | 25 g high-grade Copper Harbor ore | |
| | (80% MnO₂) | |
| | No microorganism inoculant | |
| | Cattails nutrient media | |
| Incubation period | 20 | days |
| Cattails media change frequency | 300 | mL/week |

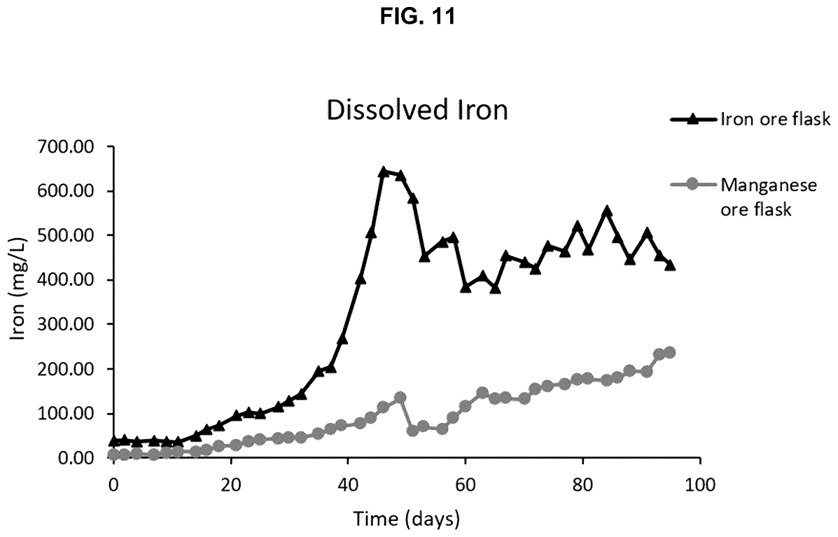

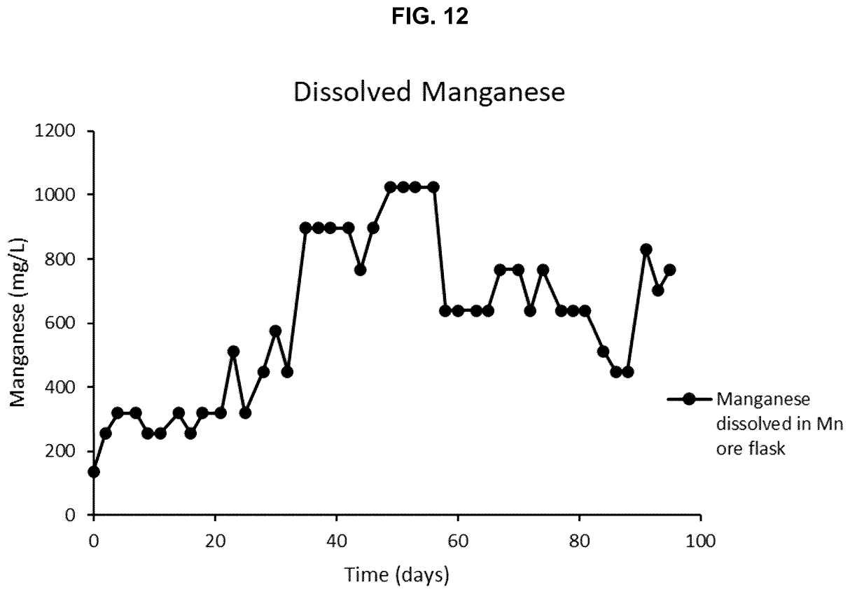

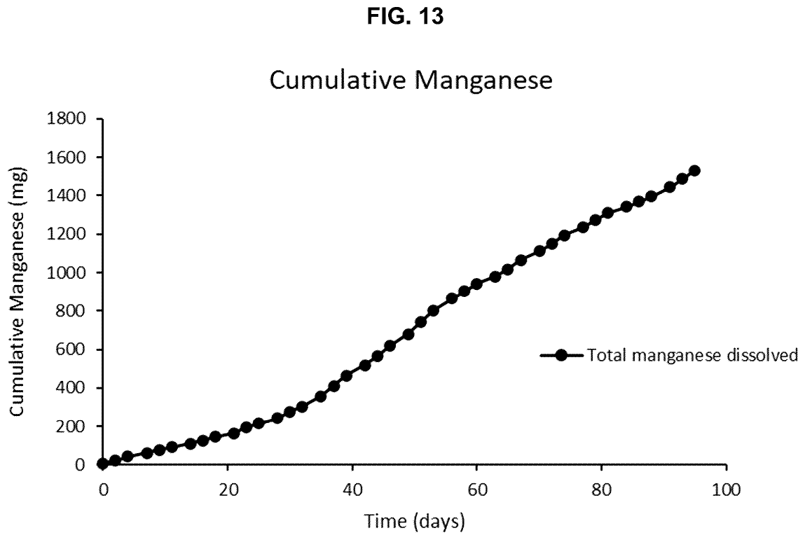

The iron ore flask contained an iron ore tailing that is rich in goethite (FeOOH) and known to be susceptible to iron dissolution by bacterial reduction. The iron ore flask reached maximum iron concentration more rapidly than the previous flasks, due to the microorganisms becoming better adapted to dissolving iron. When the peak iron concentration from the first flask was reached, roughly 80% of the iron was being reprecipitated in the second flask, but ultimately, this amount was reduced to only about 60% iron precipitation when the iron concentration dropped (FIG. 11). The manganese dissolution rate reached about 1000 ppm around this same period (FIG. 12). After about 2 months, about 1.5 g (˜1500 mg) of manganese had dissolved, which was approximately 12% of the total manganese available in the ore (FIG. 13). The Experiment 2 setup reached this point of manganese dissolution 50 days faster than the Experiment 1 setup.

While operating the first two experimental setups (Experiment 1 setup and Experiment 2 setup), it was noted that the relatively small quantity of manganese ore in the second flask in each case allowed a large amount of solution to pass through without coming into intimate contact with the ore. This was likely the cause of the incomplete precipitation of the dissolved iron in the second flask.

Iron-Manganese Two-Stage Leaching Flask Experiment 3 Setup. In the Experiment 3 setup, the ore quantity in both flasks was increased significantly (400 g iron ore, 400 g manganese ore) to improve the contact between the solution and ores, as shown in Table 3. The increased amounts of ore nearly filled the volume of the flasks where the solution being injected into the flasks was forced to percolate through the ore bed and come into intimate contact with the ore solids. Both the iron ore flask and the manganese ore flask included a cattails nutrient media as a microorganism food source, but only the iron ore flask included a microorganism inoculant comprising a culture of dissimilatory metal-reducing anaerobic bacteria.

TABLE 3
Specifications for two-stage leaching Experiment 3 setup.
Specifications

| Iron ore flask (First flask) | 400 g iron ore tailings | |
|---|---|---|
| | Microorganism inoculant from | |
| | anaerobic leaching flasks | |
| | Cattails nutrient media | |
| Manganese ore flask (Second flask) | 400 g high-grade Copper Harbor | |
| | ore (80% MnO₂) | |
| | No microorganism inoculant | |
| | Cattails nutrient media | |
| Incubation period | 5 | days |
| Cattails media change frequency | 300 | mL/week |

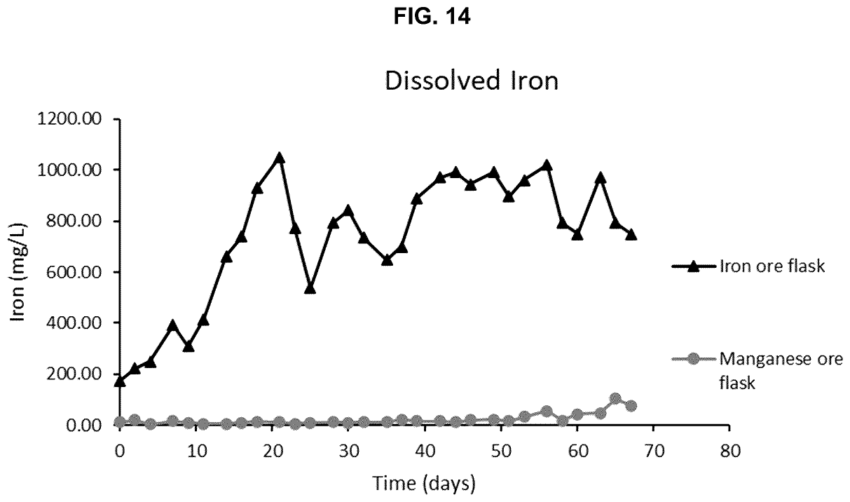

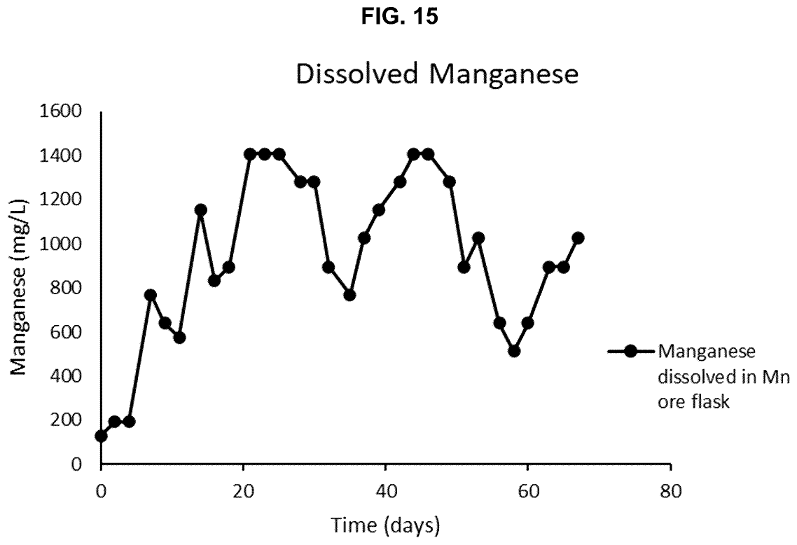

The improved contact between the ore and the solution had marked effects on the resulting iron concentrations. The iron concentration in the first flask increased to approximately 800 ppm at experimental completion (FIG. 14), as compared to roughly 400-450 ppm in the Experiment 1 and 2 setups. More importantly, the iron concentration in solution leaving the second flask was dramatically lower, approximately 50× lower than in the first flask, as shown in FIG. 14. These data demonstrated that improving the contact between the solution and the manganese ore resulted in the dissolved iron having a better opportunity to reduce the manganese and precipitate. Overall, the manganese dissolution increased markedly as a result of the improved contact with the iron-bearing solution (FIG. 15). The dissolved manganese concentration reached over 1400 ppm within only about 20 days, which was markedly higher than the approximately 500-800 ppm that is typically observed in single stage leaching processes, and higher than what was achieved in the Experiment 1 and 2 setups.

Overall, the results of these different two-stage leaching processes were surprising as it was originally assumed that the biologically dissolved iron (i.e., reduced iron) produced by the microorganisms would not be useful or suitable for dissolving the manganese as it was thought that the dissolved iron would be complexed by organic molecules making it insufficiently reactive to reduce the manganese to the soluble Mn²⁺ state. In addition, even if the reduction reaction occurred, it was originally expected that the oxidation and precipitation of the iron would be incomplete, resulting in excessive amounts of iron remaining in solution. Therefore, following the incubation periods, it was expected that the final dissolution products would contain about half iron and half manganese. However, analysis of the resulting solutions indicated that any iron that dissolved then proceeded to reduce manganese, which precipitated the iron and dissolved the manganese. As a result, the final dissolution products were almost entirely soluble reduced manganese. It was also surprising that the action of the iron allowed the manganese concentration in solution to reach higher levels than was achieved without using biologically dissolved iron as a manganese reductant.

### Example 2

### Direct Dissolution of Manganese Using Reduced Iron Solution

It was investigated whether a reduced iron (Fe²⁺) solution could directly dissolve manganese. Experiments were conducted in a 250 mL Erlenmeyer flask using reagent-grade solid manganese dioxide (MnO₂) and ferrous sulfate heptahydrate (FeSO₄·7H₂O) solution to determine the pH at which iron completely precipitates while dissolving manganese.

A measured quantity of 15 g MnO₂ was added to a solution of 10 g FeSO₄·7H₂O dissolved in 1000 mL water and allowed to react at three different pH levels for 1 hour. The solution was agitated with a magnetic stirrer continuously throughout the reaction. The natural pH of the FeSO₄·7H₂O solution was 2.0, and the pH of the solution was varied by adding sodium bicarbonate (NaHCO₃). The manganese was reduced and dissolved according to the following reaction:

$${MnO}_{2 ( s )} + 2 F {e}_{( aq )}^{2 +} + 4 {H}^{+} \to M {n}_{( aq )}^{2 +} + 2 F {e}_{( aq )}^{3 +} + 2 {H}_{2} O .$$

After allowing the solids to settle out of suspension, the manganese and iron concentrations remaining in the solution were analyzed by spectrophotometry. The experimental specifications and results are shown in Table 4.

TABLE 4
Experimental specifications and results for direct dissolution
of manganese using reduced iron solution.

| | Iron in | Manganese in | Iron | Manganese | Moles Fe |
|---|---|---|---|---|---|
| | reactants | reactants | precipitated | dissolved | precipitated/Moles |
| pH | (g) | (g) | (g) | (g) | Mn dissolved |
| 2.0 | 2.01 | 9.48 | 1.77 | 0.84 | 2.07 |
| 5.0 | 2.01 | 9.48 | 1.98 | 0.825 | 2.36 |
| 6.0 | 2.01 | 9.48 | 2.01 | 0.81 | 2.44 |

The results indicated that as the pH of the solution was increased (i.e., made more basic), the ratio of moles iron precipitated to moles manganese dissolved increased. In addition, at the lower pH levels of 2.0 and 5.0, some iron remained in the solution, while the iron was completely precipitated at pH 6.0. Further, as the pH of the solution was increased, the total amount of manganese dissolved decreased. These results demonstrated that a reduced iron solution can directly dissolve manganese in the absence of any metal-reducing microorganisms.

What is claimed:

1. A method of selectively extracting manganese from an ore, the method comprising:
incubating an ore comprising manganese-bearing oxide minerals with a solution comprising reduced iron for a period of time sufficient to generate soluble reduced manganese;
wherein the reduced iron is precipitated as insoluble iron; and
wherein a pH of the solution is maintained below about 5.5.

2. The method of claim 1, wherein the method does not generate manganese carbonate.

3. The method of claim 1, wherein the manganese-bearing oxide minerals are Mn₂O₃, MnO₂, hydrated manganese oxides, or combinations thereof.

4. The method of claim 1, wherein the soluble reduced manganese is dissolved Mn²⁺.

5. The method of claim 1, wherein the reduced iron is dissolved ferrous iron (Fe²⁺).

6. The method of claim 1, wherein the insoluble iron is Fe₂O₃, FeOOH, Fe(OH)₃, or combinations thereof.

7. The method of claim 1, wherein the pH of the solution is maintained from about 4.0 to about 5.5.

8. The method of claim 1, wherein the period of time sufficient to generate the soluble reduced manganese and the insoluble iron ranges from about 1 day to about 6 months.

9. The method of claim 1, wherein the method is performed at a temperature ranging from about 0° C. to about 35° C.

10. The method of claim 1, wherein the method is performed at a pressure ranging from about 1 atm to about 100 atm.

11. The method of claim 1, wherein the solution comprising reduced iron is first generated by incubating an ore comprising iron oxides with one or more dissimilatory metal-reducing microorganisms and a food source to generate reduced iron and carbon dioxide in the solution, and allowing the carbon dioxide to release from the solution.

12. The method of claim 11, wherein the ore comprising iron oxides comprises only iron oxides.

13. The method of claim 11, wherein the ore comprising iron oxides and the ore comprising manganese-bearing oxide minerals are the same ore.

14. The method of claim 11, wherein the ore comprising iron oxides and the ore comprising manganese-bearing oxide minerals are different ores.

15. The method of claim 11, wherein the food source comprises sugars, organic acids, water, or combinations thereof.

16. The method of claim 11, wherein the food source is derived from natural biomass.

17. The method of claim 16, wherein the natural biomass comprises decomposing cattail (Typha latifolia).

18. The method of claim 11, wherein the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof.

19. The method of claim 18, wherein the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof.

20. The method of claim 1, wherein the method is performed in situ at the natural site of the ore comprising manganese-bearing oxide minerals.

21. The method of claim 1, wherein the method is not performed in situ at the natural site of the ore comprising manganese-bearing oxide minerals.

22. The method of claim 11, wherein the method is performed in situ at the natural site of the ore comprising iron oxides.

23. The method of claim 11, wherein the method is not performed in situ at the natural site of the ore comprising iron oxides.

24. A system for selectively extracting manganese from an ore, the system comprising:
an ore comprising manganese-bearing oxide minerals; and
a solution comprising reduced iron, wherein a pH of the solution is maintained below about 5.5.

25. The system of claim 24, wherein the system does not generate manganese carbonate.

26. The system of claim 24, wherein the manganese-bearing oxide minerals are Mn₂O₃, MnO₂, hydrated manganese oxides, or combinations thereof.

27. The system of claim 24, wherein the system generates soluble reduced manganese.

28. The system of claim 27, wherein the reduced iron is precipitated as insoluble iron when the soluble reduced manganese is generated.

29. The system of claim 27, wherein the soluble reduced manganese is dissolved Mn²⁺.

30. The system of claim 24, wherein the reduced iron is dissolved ferrous iron (Fe²⁺).

31. The system of claim 28, wherein the insoluble iron is Fe₂O₃, FeOOH, Fe(OH)₃, or combinations thereof.

32. The system of claim 24, wherein the pH of the solution is maintained from about 4.0 to about 5.5.

33. The system of claim 24, wherein the system operates at a temperature ranging from about 0° C. to about 35° C.

34. The system of claim 24, wherein the system operates at a pressure ranging from about 1 atm to about 100 atm.

35. The system of claim 24, wherein the solution comprising reduced iron is generated by incubating an ore comprising iron oxides with one or more dissimilatory metal-reducing microorganisms and a food source to generate reduced iron and carbon dioxide in the solution, wherein the carbon dioxide is released from the solution.

36. The system of claim 35, wherein the ore comprising iron oxides comprises only iron oxides.

37. The system of claim 35, wherein the ore comprising iron oxides and the ore comprising manganese-bearing oxide minerals are the same ore.

38. The system of claim 35, wherein the ore comprising iron oxides and the ore comprising manganese-bearing oxide minerals are different ores.

39. The system of claim 35, wherein the food source comprises sugars, organic acids, water, or combinations thereof.

40. The system of claim 35, wherein the food source is derived from natural biomass.

41. The system of claim 40, wherein the natural biomass comprises decomposing cattail (Typha latifolia).

42. The system of claim 35, wherein the one or more dissimilatory metal-reducing microorganisms comprise anaerobic bacteria selected from Bacillus, Geobacter, Shewanella, Acidithiobacillus, Desulfuromonas, Desulfovibrio, Ferrimicrobium, Acidiphilium, Acidocella, Acidobacterium, Ferroplasma, Sulfobacillus, Alicyclobacillus, Acidimicrobium, Ferrithrix, Acidicaldus, Acidiplasma, Geothermobacterium, Geothermobacter, Geoglobus, Geogemma, Ferroclobus, Ferroglobus, Rhodoferax, Myxococcales, Anaeromyxobacter, or combinations thereof.

43. The system of claim 42, wherein the one or more dissimilatory metal-reducing microorganisms comprise anaerobic bacteria selected from Bacillus cereus, Geobacter metallireducens, Shewanella alga, Acidithiobacillus ferrooxidans, Shewanella putrefaciens, Desulfuromonas acetoxidans, Desulfuromonas palmitatis, Desulfovibrio desulfuricans, Shewanella gelidimarina, Shewanella frigidimarina, Shewanella livingstonensis, Ferrimicrobium acidiphilum, Acidiphilium cryptum, Acidiphilium acidophilum, Acidocella facilis, Acidobacterium capsulatum, Ferroplasma acidiphilum, Sulfobacillus thermosulfidoxidans, Sulfobacillus acidophilus, Sulfobacillus benefaciens, Alicyclobacillus tolerans, Acidimicrobium ferrooxidans, Ferrithrix thermotolerans, Acidicaldus organiforans, Acidiplasma cupricumulans, Geothermobacterium ferrireducens, Geothermobacter ehrlichii, Geoglobus ahangari, Geogemma pacifica, Ferroclobus pacificus, Geogemma barossii, Geogemma indica, Ferroglobus indicus, Rhodoferax ferrireducens, or combinations thereof.

44. The system of claim 24, wherein the system operates in situ at the natural site of the ore comprising manganese-bearing oxide minerals.

45. The system of claim 24, wherein the system does not operate in situ at the natural site of the ore comprising manganese-bearing oxide minerals.

46. The system of claim 35, wherein the system operates in situ at the natural site of the ore comprising iron oxides.

47. The system of claim 35, wherein the system does not operate in situ at the natural site of the ore comprising iron oxides.
